(19) United States
(12) Patent Application Publication
(10) Pub. No.: US 2012/0084145 A1
(43) Pub. Date: Apr. 5, 2012

(54) METHOD, SYSTEM AND COMPUTER-READABLE STORAGE MEDIUM FOR DYNAMICALLY SELECTING AND PROVIDING ADVERTISEMENTS BASED ON ACCESS CHANNELS OF CONTENT

(75) Inventor: Jae Gook LIM, Seongnam-si (KR)

(73) Assignee: NHN BUSINESS PLATFORM CORPORATION, Seongnam-si (KR)

(21) Appl. No.: 13/244,201

(22) Filed: Sep. 23, 2011

(30) Foreign Application Priority Data
Sep. 30, 2010 (KR) 10-2010-0095589

(51) Int. Cl. G06Q 30/02

(52) U.S. Cl. 705/14.46; 705/14.73

(57) ABSTRACT

Disclosed herein are a method, a system, and a computer-readable storage medium for dynamically selecting and providing advertisements based on access channels of content. The method for dynamically providing advertisements using a computer, the method includes receiving a request for access to content of a content owner; determining an access channel for accessing the content, based on the request, using the computer; selecting an advertisement based on the access channel; and providing a content integration screen including the advertisement and the requested content.

### CROSS-REFERENCE TO RELATED APPLICATIONS

This application claims priority from and the benefit of Korean Patent Application No. 10-2010-0095589, filed on Sep. 30, 2010, which is hereby incorporated by reference for all purposes as if fully set forth herein.

### BACKGROUND OF THE INVENTION

1. Field of the Invention

Exemplary embodiments of the present invention relates to a method, a system, and a computer-readable storage medium for dynamically selecting and providing advertisements based on access channels of content.

2. Discussion of the Background

Recently, in accordance with the generalization of Internet usage, Internet users may obtain various types of information through the Internet. Further, Internet users may utilize content of interest, by accessing web sites of content owners via an Internet search site or a portal site, or by directly inputting an address of a web site using a terminal device, such as a personal computer, or the like, capable of accessing the Internet.

As the number of Internet users who search for desired content through the Internet increases, enterprises owning content (hereinafter, referred to as “content owners”) have attempted to make profits by providing advertisements along with the content to users accessing the content through their web pages. However, many Internet users utilize an Internet search site or a portal site (hereinafter, referred to as content brokers) to search and access web pages providing the content of interest rather than directly accessing the web pages provided by the content owners. Therefore, there is a consensus among some advertisers that the web pages of the content owners are not effective channels for advertising products and/or services. Rather, the advertisement demands of the content brokers are higher than the advertisement demands of individual content owners.

Further, several content brokers have provided services for exposing content of the content owners to Internet users, in response to a search or without a search, to increase the exposure of content to users, through the content brokers. However, a number of content owners have failed to exploit their content to increase sales through direct advertisement using the web pages of the content owner, due to the web pages having low exposure rates, and have failed to exploit the popularity of the content broker to gain higher advertisement profits.

Furthermore, some content owners have published less effective advertisements that are not associated with their web pages or their content and may harm their long-term profit by losing their faithful users in order to increase short-term advertisement profit (i.e., an adult advertisement on news media websites, pornography-related advertisements, and the like). As a result, long-term advertisement profit for the content owners may decrease, and the trustworthiness of the content broker exposing the corresponding content may also be harmed by inappropriate advertisement content displayed by the web pages of the content owners.

### SUMMARY OF THE INVENTION

Exemplary embodiments of the present invention provide a method, a system, and a computer-readable storage medium for dynamically selecting and providing advertisements based on access channels of content. In the method, system, and computer-readable storage medium, access channels of content may be identified at the time of provision of the content, corresponding different advertisements may be dynamically selected based on the access channels, and the selected advertisements may be provided to users.

Exemplary embodiments of the present invention provide a method for determining access channels of content requested by users for an access and providing different advertisements based on the access channels, thereby providing higher advertisement profits to content owners using higher medium force and sale force of a content broker, and providing the content broker extended advertisement space using web pages of the content owners.

Exemplary embodiments of the present invention provide a method for providing an appropriate advertisement different from an advertisement of content owners if the users access content of the content owners through a content broker, such that advertisements are selected based on the type of the content of the content owners, thereby increasing advertisement matching ratio with the content, maximizing advertisement profit and maintaining users' reliability for the content broker.

Exemplary embodiments of the present invention provide a method for sharing a profit between a content broker and a content owner if users access the content of the content owner through the content broker to generate an advertisement profit.

Additional features of the invention will be set forth in the description which follows, and in part will be apparent from the description, or may be learned by practice of the invention.

Exemplary embodiments of the present invention provide a method for dynamically providing advertisements using a computer, the method including receiving a request for access to content of a content owner; determining an access channel for accessing the content, based on the request, using the computer; selecting an advertisement based on the access channel; and providing a content integration screen including the advertisement and the requested content.

Exemplary embodiments of the present invention provide a system to provide advertisements dynamically, the system including access channel analyzing unit to receive a request to access to content of a content owner, and to determine an access channel for accessing the content based on the request; and dynamic advertisement selecting unit to select an advertisement based on the access channel, and to provide a content integration screen to a display unit, the content integration screen including the advertisement and the content.

Exemplary embodiments of the present invention provide a non-transitory computer-readable storage medium including an executable program, which when executed, operates to receive a request to access to a content of a content owner from a terminal; determine an access channel of the content, based on the request; select an advertisement of a content broker connected to the access channel; and provide a content integration screen including the advertisement and the content.

Exemplary embodiments of the present invention provide a system to provide advertisements dynamically, the system including access channel analyzing unit to receive a request to access content of a content owner, and to determine an access channel for accessing the content based on the request; and dynamic advertisement selecting unit to select an advertisement of a content broker if the access channel is determined to be via the content broker, and to provide a content integration screen in response to the request, the content integration screen including the advertisement of the content broker and the content of the content owner.

Exemplary embodiments of the present invention provide a method for dynamically providing advertisements using a computer, the method including receiving a request for access to content of a first content owner; selecting an advertisement based on the request; providing a first content integration screen including the advertisement and the content of the first content owner; identifying a number of executions of the advertisement through the first content integration screen; and calculating an advertisement profit for the first content owner, based on the number of executions of the advertisement through the first content integration screen.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a system to determine access channels of content and dynamically provide advertisements based on the access channels of the content according to an exemplary embodiment of the present invention.

FIG. 2 is a diagram showing a dynamic advertisement providing system 200 according to an exemplary embodiment of the present invention.

FIG. 3 and FIG. 4 are diagrams showing dynamic provisions of advertisements in a content integration screen according to an exemplary embodiment of the present invention.

FIG. 5 is a flowchart showing a procedure of adding an identification marker according to an exemplary embodiment of the present invention.

FIG. 6 is a flowchart showing a procedure of dynamically selecting and providing advertisements in response to a request for access to corresponding content by a user according to an exemplary embodiment of the present invention.

FIG. 7 is a flowchart showing a procedure of calculating advertisement profit generated by advertisement execution and profit sharing amounts according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

In the present description, content may refer to various information or materials provided through the Internet, computer communication, or the like. Further, the content may refer to something that is to be expressed through an electronic medium. For example, the content may refer to various types of information, such as a character, a sign, an audio clip, a video clip, an image, and the like, produced, processed, and distributed in the form of digital data, so as to be used in a wired or wireless telecommunication network without being limited to a specific format.

In the present description, a database refers to stored data based on a computer file system, or the like. Further, a database may include a set of operational processing histories that can be searched to extract data.

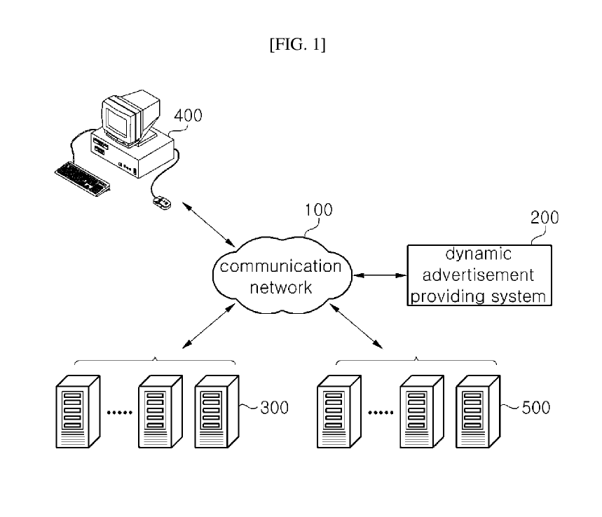

FIG. 1 is a diagram showing a system to determine access channels of content and dynamically provide advertisements based on the access channels of the content according to an exemplary embodiment of the present invention.

As shown in FIG. 1, the system includes a communication network 100, a dynamic advertisement providing system 200, a content server 300, a user terminal device 400, and a web server 500. The communication network 100 may include a wired or a wireless communication network, such as Internet, third generation wireless communication network (3G), Wi-Fi, and the like. The dynamic advertisement providing system 200 may include a unit to identify an access channel (an access path) to provide dynamically selected advertisement to the user terminal device 400. The dynamic advertisement providing system 200 may provide different advertisements based on the identified access channels. The content server 300 may include a storage unit to store content of a content owner (“a content provider”). The user terminal device 400 may include a device that is able to output an advertisement resource and to receive user instructions. The web server 500 may include a web server of a content broker that provides content-related information to the users, to induce the users to access web pages of the content owners. For example, the web server 500 of the content broker may include a website, such as a search engine site, etc, facilitating the access of users to the content server 300, such as a news site of a media company.

Further, the communication network 100 may be configured as a wired communication network, a wireless communication network or a combination thereof, and may be configured as various communication networks, such as a local area network (LAN), a metropolitan area network (MAN), a wide area network (WAN), or the like. The communication network 100 described in the present invention may be the World Wide Web (WWW).

The dynamic advertisement providing system 200 may dynamically select advertisements, based on access channels. The dynamic advertisement providing system 200 may provide the selected advertisements and specific content to users, if the users access the specific content provided by the content server 300 directly, or through the web server 500 of a content broker.

The dynamic advertisement providing system 200 may add identification markers of content owners and/or content brokers, to access information of content owned by the content owners. The dynamic advertisement providing system 200 may recognize access channels of the content, based on the identification markers.

The dynamic advertisement providing system 200 may calculate advertisement profits generated by advertisement execution. The dynamic advertisement providing system 200 may divide the advertisement profits between the content broker and the content owners.

Although FIG. 1 shows that the dynamic advertisement providing system 200 is configured separately from the content server 300 and the web server 500, the dynamic advertisement providing system 200 may be configured such that a portion of or all the operations thereof may be included in the content server 300 or the web server 500.

Further, the content server 300 may be a server storing content of content owners and providing the content to users accessing the content server 300 directly or via the web server 500 of the content broker indirectly. The content server 300 may be a database server storing content and providing the content in connection with a web server of the content owner. In addition, the content server 300 may refer to a plurality of content servers of more than one content owner.

The user terminal device 400 may include a digital device capable of accessing the web server 500 of the content broker and communicating therewith. Any digital device, such as a personal computer (i.e., a desktop computer, a laptop computer, or the like), a workstation, a personal digital assistance (PDA), a portable multimedia player (PMP), a web pad, a mobile phone, or the like, may be used as the user terminal device 400 as long as it includes a memory unit and a microprocessor mounted therein to have operational capability. In addition, the user terminal device 400 may further include a web browser (not shown) program allowing the user to access and receive the content of the content owner using a search operation or without the search operation.

The web server 500 of the content broker may communicate with the dynamic advertisement providing system 200, the content server 300, and/or the user terminal device 400. Further, the web server 500 of the content broker that may contain a web page providing a search function may provide some of the content stored in the content server 300 to the user terminal device 400 in response to a search operation of the user or without the search operation and allow the user to be exposed to specific content and a selected advertisement corresponding to the access channel of the specific content by communicating with the content server 300 and/or the dynamic advertisement providing system 200 if the user selects the specific content.

Hereinafter, each component of the dynamic advertisement providing system according to an exemplary embodiment of the present invention will be described.

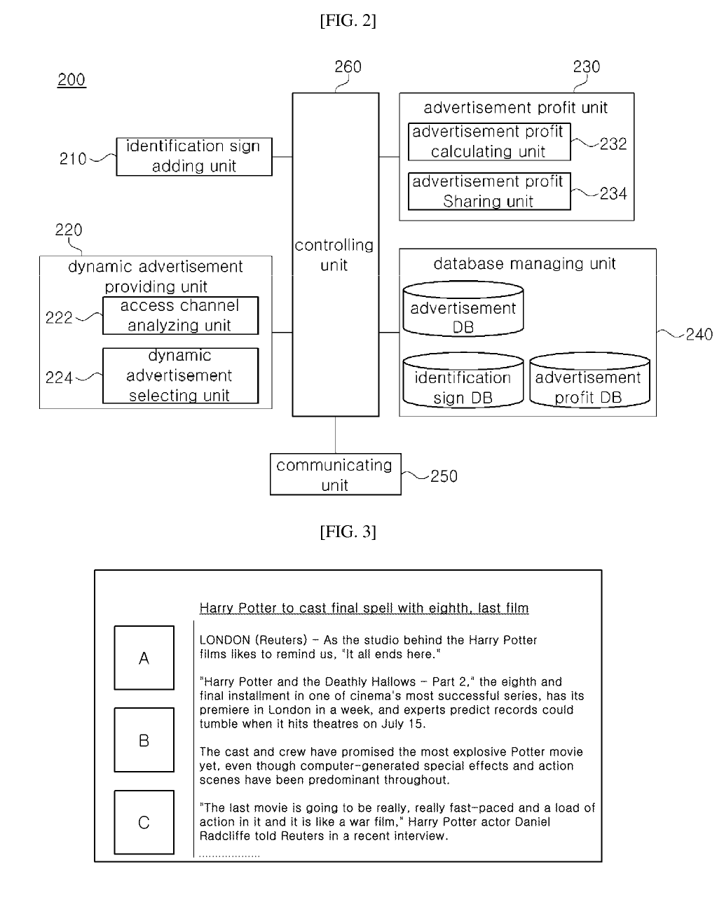

FIG. 2 is a diagram showing a dynamic advertisement providing system 200 according to an exemplary embodiment of the present invention. Referring to FIG. 2, a dynamic advertisement providing system 200 includes an identification sign adding unit 210, a dynamic advertisement providing unit 220, an advertisement profit unit 230, a database managing unit 240, a communicating unit 250, and a controlling unit 260. The dynamic advertisement providing unit 220 may include an access channel analyzing unit 222 and a dynamic advertisement selecting unit 224.

A portion of the operations of the identification sign adding unit 210, the dynamic advertisement providing unit 220, the advertisement profit unit 230, the database managing unit 240, the communicating unit 250, and the controlling unit 260 may be implemented as program modules communicating with the content server 300, the user terminal device 400, and/or the web server 500 of the content broker. These program modules may be included in a form of an operating system, an application program module and other program module in the dynamic advertisement providing system 200, and be physically stored on one or more storage devices. In addition, these program modules may also be stored in a remote storage device capable of communicating with the dynamic advertisement providing system 200. Further, a portion of or all of each component and/or database of the dynamic advertisement providing system 200 may be implemented in a physically separated device. These program modules include a routine, a sub-routine, a program, an object, a component, a data structure, or the like, performing a specific task or executing a specific abstract data type to be described below according to exemplary embodiments of the present invention. However, it is not limited thereto.

The identification sign adding unit 210 may receive access information for accessing specific content from the content server 300. The identification sign adding unit 210 may add an identification marker of a content broker and/or a content owner to the received access information.

If the dynamic advertisement providing system 200 includes the identification sign adding unit 210, the dynamic advertisement providing system 200 may modify uniform resource locator (URL) setting of the content server 300 or the web server 500 of the content broker, to add the identification marker.

The identification sign adding unit 210 may be included in and be operated in the content server 300 or the web server 500 of the content broker. In this case, the identification sign adding unit 210 may add identification information of specific content, a content provider, and/or a content broker to a URL through which the user access the content according to a predetermined protocol. If a user accesses the content through a link referring to the URL, the identification information included in the URL may be directly or indirectly transferred to the dynamic advertisement providing system 200. The access channels may be analyzed based on the transferred identification information.

The access information may be included in a URL through which content may be directly or indirectly accessed. For example, the access information may be indicated in a URL, such as http://www.coa.com/content_id=1234, or the like, by using a variable ‘content_id’ as an identification marker of the content. Here, an identification value of the identification marker of the content is 1234. If the identification sign adding unit 210 receives the access information, the identification sign adding unit 210 may add identification markers of a content broker and a content owner to the access information. For example, the identification sign adding unit 210 retrieves identification information of a content broker (i.e., NAVER), which is an identification value of the content broker stored in an identification marker database for the access information, and adds the identification value of a content broker as a value of the identification marker of the content broker. The identification marker of the content broker may be the variable, ‘content_broker_id’. Further, the identification sign adding unit 210 retrieves identification information of a content owner (i.e., ABC), which is an identification value of the content owner stored in the identification marker database for the access information, and adds the identification value of the content owner as a value of the identification marker of the content owner. The identification marker of the content owner may be the variable, ‘content_owner_id’. The modified URL may be “http://www.coa.com/content_id=1234&content_broker_id=NAVER&content_owner_id=ABC”. The addition of the access information and the identification marker may be performed using the GET method of hypertext markup language (HTML), but it is not limited as such.

The dynamic advertisement providing unit 220 may analyze the access channel of specific content in response to a request for an access to the specific content, dynamically select advertisements based on the access channel, allocate the selected advertisements at an advertisement area of the web page or a content integration screen, and expose the selected advertisements along with the content.

More specifically, the access channel analyzing unit 222 may receive information of the request for an access to the specific content through the user terminal device 400 and analyze the access channel. For example, if the access channel analyzing unit 222 receives the information of the request for an access to the specific content, i.e., http://www.coa.com/content_id=1234&content_broker_id=NAVER&content_owner_id=ABC, the access channel analyzing unit 222 identifies NAVER, which is a value corresponding to a variable ‘content_broker_id’, and determines whether the value, NAVER, coincides with a value of the identification marker of the content broker stored in the identification marker database. If the value corresponding to the variable ‘content_broker_id’ coincides with a value of the identification marker of the content broker stored in the identification marker database, the access channel analyzing unit 222 may determine that the request for an access to the specific content is made through the content broker, NAVER. If there is no value corresponding to the value of the variable ‘content_broker_id’ in the access information (for example, when the information on the request for access to the content is “http://www.coa.com/content_id=1234”), the access channel analyzing unit 222 may determine that the request for an access to the specific content is not made through a content broker. If a value is identified for the variable ‘content_broker_id’ but does not coincide with a value of the identification marker of content brokers stored in the identification marker database, the access channel analyzing unit 222 may perform one of the following operations. The access channel analyzing unit 222 may determine the request for an access to the content is not made through the content broker, display an error message or redirect to a specific web page, or the like. Further, the access channel analyzing unit 222 may store the identified value for the variable ‘content broker_id’ to the identification marker database.

In addition, the dynamic advertisement selecting unit 224 selects advertisements corresponding to the access channel of the request for an access to the content determined by the access channel analyzing unit 222 and provides a content integration screen including the selected advertisements and the content requested by the user. That is, if it is determined that the request for an access to the content was made through the content broker, the dynamic advertisement selecting unit 224 generates a channel for exposing an advertisement of the content broker. An example of the channel may be a URL such as “http://ad.naver.com/adshow?unit=1&content_owner_id=ABC”. The advertisement of the content broker may include an advertisement to be provided if an access to specific content is performed through the content broker. The advertisement of the content broker may include an advertisement associated with the content broker, an advertisement sold through an advertisement network associated with the content broker, and an advertisement having targeting information associated with the content broker.

If it is determined that the request for an access to the specific content is not made through the content broker, the dynamic advertisement selecting unit 224 generates a channel for exposing an advertisement of the content owner. An example of the channel may be a URL such as “http://ad.coa.com/ad=coal”.

The term, ‘advertisement of content owner’, is not interpreted as being limited to an advertisement of a person owning an intellectual property of the content. The advertisement of content owner may be an advertisement associated with the content server 300 and the content provider who directly provides the content. The advertisement associated with the content server 300 may include an advertisement associated with the content provider, an advertisement sold through an advertisement network associated with the content provider, and an advertisement having targeting information associated with the content provider and the content server 300.

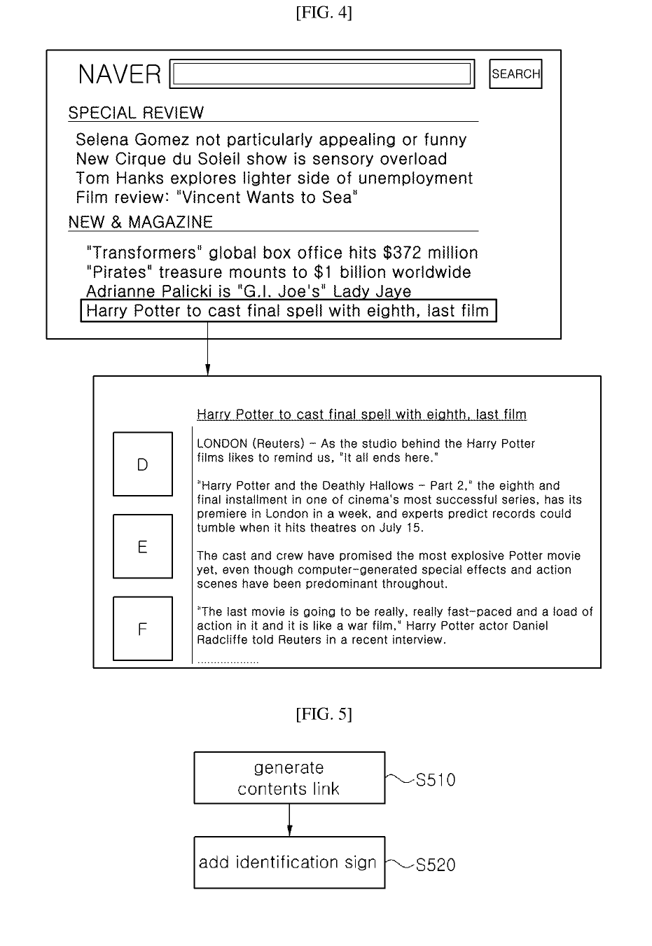

The content integration screen (i.e., a web page integrated with the content and the selected advertisement) may be divided into a content area and an advertisement area. The content integration screen may also be provided to the user by linking a URL corresponding to the advertisement exposure channel as described above to the advertisement area and linking a URL corresponding to the channel of the content requested by the user to the content area. An example of the content integration screen will be described in more detail with reference to FIG. 3 and FIG. 4.

The advertisement profit unit 230 may calculate advertisement profit and an allocated portion (“shared-portion”) of the advertisement profit for each of the content owners and the content broker.

More specifically, an advertisement profit calculating unit 232 may calculate the advertisement profit for an advertisement of the content broker based on the execution of the advertisement. Here, the advertisement execution (the execution of the advertisement) may be determined according to an advertisement scheme (“an advertisement execution method”). For example, in a cost per millennium (CPM) scheme, an exposure of the advertisement may be regarded as the advertisement execution, such that the advertisement profit may be calculated according to the number of advertisement exposures. In a cost per time (CPT) scheme, the advertisement profit may be calculated based on an advertisement publishing time, a time period during the advertisement is published. In a cost per click (CPC) scheme, clicks on advertisement information may be regarded as the advertisement execution, such that the advertisement profit may be calculated according to the number of the clicks on the corresponding advertisement. In a cost per action (CPA) scheme, a determined action result (i.e., purchase of a product, or the like) of the user may be regarded as the advertisement execution, such that the advertisement profit may be calculated based on the number of the determined action results.

In addition, an advertisement profit sharing unit 234 may calculate an accumulated amount of the advertisement profit generated due to the advertisement execution and calculate the allocated portion of the advertisement profit for each of the content owner and the content broker such that the advertisement profit to be shared between the content owner and the content broker according to a predetermined protocol.

If a single content broker advertises content of ‘A’ number (A indicates a natural number) of content owners and provides ‘X’ number of (X indicates a natural number) advertisements (a1 to aX), the total number of advertisement executions generated for each advertisement is Ta1 to Tax, respectively (i.e., the total execution number generated for the advertisement ‘aX’ is Tax). The number of advertisement executions generated for each advertisement with respect to content owner ‘b’ COb (0<b≦A, b indicates a natural number) among the total number of advertisement executions is Na1 to Nax, respectively (i.e., the execution number generated for the advertisement ‘a1’ with respect to content owner ‘b’ is Na1). An advertisement profit generated by the execution of each advertisement is Pa1 to Pax, respectively. A profit sharing amount for content owner ‘b’ (COb) during a predetermined period may be calculated as follows.

$$Total profit sharing amount of {Co}_{b} during predetermined period = {\sum }_{i = 0}^{x} ( {P}_{ai} * \frac{{N}_{ai}}{{T}_{ai}} ) * {RSR}_{{CO}_{b}} \qquad [ Equation 1 ]$$

(Where RSRCOb indicates a profit sharing ratio for the content owner ‘b’, COb).

An advertisement profit sharing may be performed by calculating the portion of the advertisement profit (“profit sharing amount”) allocated for each of the content owners and the content broker.

$${\sum }_{i = 0}^{X} ( {P}_{ai} \times \frac{{N}_{ai}}{{T}_{ai}} )$$

may be a factor for allocating the advertisement profit among multiple content owners and a factor for applying a contribution ratio of each content owner. RSRCOb may be a factor for allocating the advertisement profit between a content owner and the content broker. RSRCOb may be determined based on the ratio between the number of direct access to the web page of the content owner and the number of indirect access to the web page of the content owner via the content broker.

The advertisement profit sharing may be performed per a predetermined period of time, (i.e., on a monthly basis, on a quarterly basis). Further, an advertisement profit amount generated for each advertisement, a profit sharing ratio of the content owner, and the like, may be changed according to a contract condition between the advertiser (or the content owner) and the content broker.

The advertiser may provide an advertisement to be advertised via the content broker and/or the content owner and pay an advertisement fee to the content broker. The content broker may advertise the advertisement for the advertiser via the web pages of the content owners, if the web pages are visited via the content broker, and receives the advertisement fee from the advertiser as advertisement sales (or advertisement profit). The content owners provide their web pages for advertising the advertisement of the advertiser, if the web pages are visited via the content broker. The content owners receive an allocated portion of the advertisement fee from the content broker.

Using this method, the content broker may utilize web pages of content owners as extended online advertisement spaces, as well as the web pages of the content broker. Further, the content broker may allocate appropriate advertisement resources to the web pages of the content owners, based on attribute information of the web pages of the content owners and attribute information of the advertisement resources.

Further, the content broker may allocate appropriate advertisement resources to the web pages of the content owners based on a keyword used for searching the web pages of the content owners and the attribute information of the advertisement resources. The attribute information of the advertisement resources may include advertisement type information. If the keyword used for searching the web pages of the content owners is matched with the advertisement type information of the advertisement, the advertisement may be selected to be displayed with the content of the web pages of the content owners. If a web page of a used-car seller is retrieved according to a search keyword, ‘used car’, an advertisement resource related to ‘car’ may be displayed along with the content of the web page of the used-car seller in a content integration screen.

The database managing unit 240 may include an advertisement database (DB) in which advertisement content of the advertiser is stored, an identification marker database (DB) in which the identification markers of the content brokers and the content owners and the identification values of the content brokers and the content owners are stored, and an advertisement profit database (DB) in which the advertisement profit calculated based on the advertisement execution, the allocated portion of the advertisement profit for each of the content owners and the content broker (profit sharing amount between the content owners and the content brokers), and the like, are stored. The advertisement DB may be configured to be located in the content server 300.

The communicating unit 250 may serve to enable the dynamic advertisement providing system 200 to transmit and receive data to and from other devices.

The controlling unit 260 may control data transmissions among the identification sign adding unit 210, the dynamic advertisement providing unit 220, the advertisement profit unit 230, the database managing unit 240, and the communicating unit 250. Further, the controlling unit 260 controls data transmissions from the outside, to the outside or between each component of the dynamic advertisement providing system 200, thereby controlling the identification sign adding unit 210, the dynamic advertisement providing unit 220, the advertisement profit unit 230, the database managing unit 240, and the communicating unit 250 so as to perform their own operations.

Although an exemplary embodiment of the present invention provides the databases classified into the advertisement DB, the identification marker DB, and the advertisement profit DB in the above-mentioned description, a configuration of the databases including these classifications may be changed by those skilled in the art as needed.

FIG. 3 and FIG. 4 are diagrams showing dynamic provisions of advertisements in a content integration screen according to an exemplary embodiment of the present invention.

FIG. 3 is a view showing a screen (i.e., a web browser display) of a web page of a content owner, which is displayed if a user accesses the web page without utilizing the content broker (i.e., if a user accesses specific content of the content owner directly or through the user's link). Referring to FIG. 3, the screen may include a content area (right side) and an advertisement area (left side). The content area, which is an area in which content of the content owners is displayed, provides the same content regardless of access channels of the content. That is, the content displayed on the content area is the same, regardless of whether the user accesses the content via the content broker. The advertisement area is an area in which advertisements are provided. Advertisements selected by the content owner may be provided on the advertisement area if the content is accessed by the user without utilizing the content broker. For example, advertisement A, advertisement B, and advertisement C are selected by the content owner, according to contracts between the content owner and advertisers of the advertisements A, B, and C. The advertisements A, B, and C may be advertisements of content owners to be provided to users who access the content of the content owner. However, dynamically changed advertisements based on the access channels of the content by the users, may be provided in the advertisement area, if the users access the content via the content broker.

FIG. 4 is a view showing a web page of a content broker including a link to access specific content of a content owner, and a content integration screen displayed if a user accesses specific content of a content owner through the web page of a content broker. As shown in the upper portion of FIG. 4, the web server of the content broker provides an access channel allowing the user to access the specific content of the content owner. As an example of the access channel, a specific phrase displayed in a box and a specific URL linked to the phrase may be provided. If the user accesses the specific content through the content broker, by, for example a click on the specific phrase, or the like, a content integration screen having the content area and the advertisement area may be displayed. The content integration screen may appear in a new browser (or in a new tab) separately from a browser showing a web page on which an existing content is displayed. In the alternative, the content integration screen may be displayed on the existing browser by redirecting from the browser showing the web page of the existing content provider, or the like, as shown in a lower portion of FIG. 4. Advertisement D, advertisement E, and advertisement F, which are advertisements provided by the content broker, are provided to the users. In an example, the advertisement D, E, and F may be replaced with the advertisement A, B, and C shown in FIG. 4. Further, the advertisement D, E, and F may be displayed in an advertisement area of the content integration screen, along with at least one of the advertisement A, B, and C. The advertisement area may be determined by identifying advertisement-related tags or specific source code of the web page of the content owners. Further, RSRCOb may be determined differently based on whether the advertisement of the content broker replaces the advertisement of the content owner. For example, RSRCOb may be increased if the advertisement of the content broker replaces the advertisement of the content owner. In this way, the content owner may make up for the loss of an advertisement profit according to the replacement of the advertisement of the content owner. Comparing FIG. 4 with FIG. 3, regardless of whether or not the specific content is accessed through the web server of the content broker, content of the content areas are the same. However, the advertisements provided in the advertisement areas are dynamically changed, according to the access channel. The dynamic advertisement providing unit 220 dynamically provides various advertisements, based on the access channels of the content accessed by the users.

Further, if a user accesses the content of the content owner through the content broker, more advertisements may be provided on a limited advertisement area, based on several schemes. For example, schemes based on a display time for the display of the content on the content integration screen, based on the number of existing advertisement executions, or based on provisions of randomly selected advertisements, may be used.

Although FIG. 3 and FIG. 4 show that the advertisement area is positioned on the left of the content area, the position of the advertisement area may be changed. The advertisement area may be positioned at various positions according to the structure of the web page of the content owner. For example, the advertisement area may be positioned at the right, an upper portion, or a lower portion, or at the center of the content area, or on a portion of the content area by overlapping the advertisement.

Hereinafter, a procedure from a generation of content to profit sharing based on an advertisement execution will be described in more detail.

FIG. 5 is a flowchart showing a procedure of adding an identification marker according to an exemplary embodiment of the present invention.

If content of a content owner is determined to be provided through a content broker, access information is generated (S510) and the access information may be received by the identification sign addition unit 210. The access information may be used to determine the access channel and to access the corresponding content. For example, the content may be a newspaper article, the content owner may be a newspaper company, and the access information through which the content may be accessed may be a specific URL through which the corresponding newspaper article may be viewed.

The identification sign adding unit 210 adds identification information to the access information in order to determine the access channel based on the received access information in response to a request for an access to the content (S520). The identification information may include an identification marker (a specific variable indicating a type of an identification value), and an identification value (a value indicating a specific content owner or a specific content broker). However, an example of the identification information is not limited thereto, and may include other information. The specific variable name and value of the identification marker may be predefined and stored in the identification marker database, or the value may be retrieved from the identification marker database and then used when adding the identification marker.

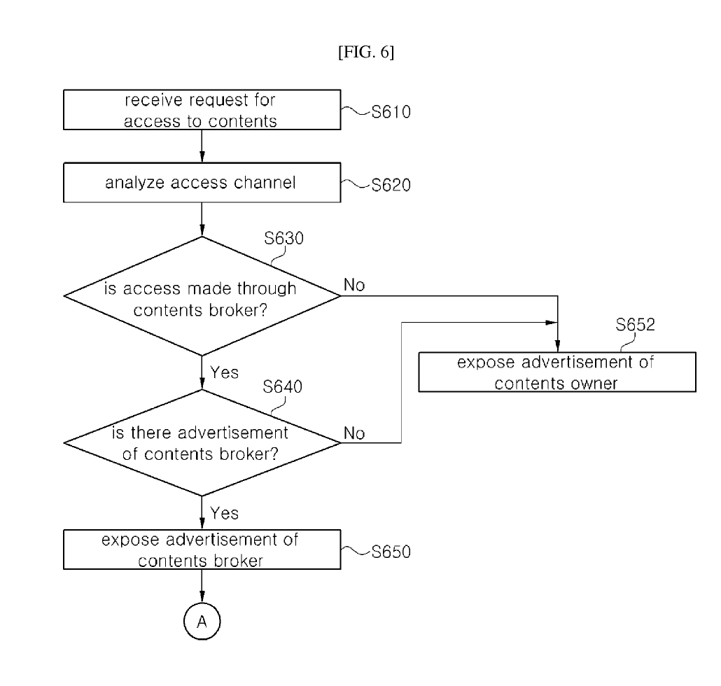

FIG. 6 is a flowchart showing a procedure of dynamically selecting and providing advertisements in response to a request for access to corresponding content by a user according to an exemplary embodiment of the present invention.

If a user attempts to access specific content, the access channel analyzing unit 222 receives a request for an access to content from the user terminal device 400 (S610). The access attempt by the user may be generated by inputting a specific URL through an address window (“address bar”) of a web browser (not shown) provided by the user terminal device 400 or by performing an action such as clicking on a link to a specific URL provided by the web server 500 of the content broker. In this case, the request for an access to content received by the access channel analyzing unit 222 may be specific URL information.

Then, the access channel analyzing unit 222 may analyze the received request for an access to content (S620). For example, the analyzing operation may be performed by analyzing the access information, to determine whether an identification marker and an identification value of the identification information is stored in the identification marker database.

The access channel analyzing unit 222 determines the access channel of the request, based on the analysis of the access information. The access channel analyzing unit 222 transmits information of the access channel to the dynamic advertisement selecting unit 224 (S630).

If the request is made through the content broker, the dynamic advertisement selecting unit 224 determines whether there is an advertisement of the content broker (S640). If an advertisement of the content broker exists, the advertisement of the content broker is provided (S650). Further, the advertisement of the content broker may be provided by linking a URL of a specific web page for providing the advertisement of the content broker stored in the advertisement database to an advertisement area in a content integration screen.

If the request for an access to content is not made through the content broker, or if the request is made through the content broker but there is no advertisement of the content broker corresponding to the request, an advertisement of the content owner is provided (S652). The advertisement of the content owner may be provided by linking a URL of a specific web page, for providing the advertisement of the content owner stored in the advertisement database, to the advertisement area in the content integration screen, or the original web page of the content owner may be provided.

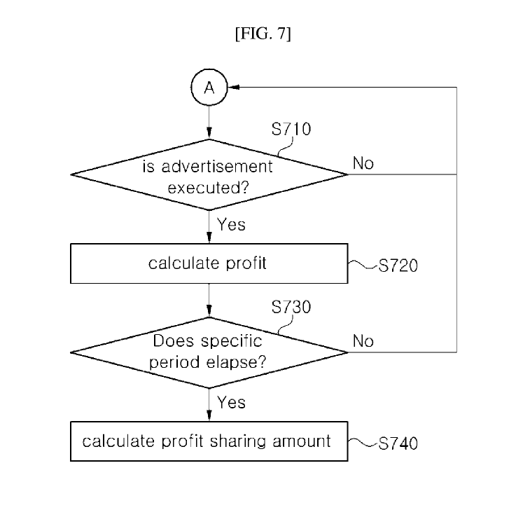

FIG. 7 is a flowchart showing a procedure of calculating advertisement profit generated by advertisement execution and profit sharing amounts, according to an exemplary embodiment of the present invention.

The advertisement profit calculating unit 232 determines whether an advertisement provided to a user is executed (displayed) (S710). Here, the determination of whether the advertisement is executed may vary, according to an advertising charging method as described above. For example, in the CPM scheme, a provision of an advertisement to the user may be regarded as the advertisement execution. Since the profit sharing is made with respect to the advertisement of the content broker if the advertisement of the content broker is displayed on the web page of the content owner, the determination of whether the advertisement is executed may be considered for the advertisement of the content broker. However, the present invention is not limited thereto. For example, advertisement profit generated by an advertisement of the content owner may be shared with the content broker, if the advertisement of the content owner is accessed via the content broker. Thus, whether the advertisement of the content owner is executed via the content broker may be determined and the advertisement profit may be shared with the content broker.

If the execution of the advertisement is determined, the advertisement profit calculating unit 232 calculates advertisement profit of the advertisement (S720) and stores a result of the calculation in the advertisement profit database. If the advertisement profit is represented by a value obtained by multiplying the number of advertisement executions by a unit cost of the advertisement execution, the advertisement profit calculating unit 232 may calculate the number of advertisement executions, the unit cost of the advertisement execution, and an advertisement profit, and then store them in the advertisement profit database. However, the present invention is not limited thereto. For example, the advertisement profit calculating unit 232 may calculate advertisement profit based on the above-mentioned various advertisement schemes and then store them in the advertisement profit database, according to the advertisement profit calculation scheme.

In addition, the advertisement profit sharing unit 234 determines whether or not a stipulated period for sharing an advertisement profit has elapsed (S730) and calculates an advertisement profit sharing amount (an allocated portion of the advertisement profit for each of the content owner and the content broker), according to a predefined condition, if the advertisement profit sharing occurs (S740). Although FIG. 7 shows that the operation (S740) is performed after it is determined whether the specific period has elapsed, the present invention is not limited thereto. For example, the advertisement profit sharing amount may be calculated and updated based on the calculated advertisement profit if the advertisement is executed, or may be separately calculated for each period in which it is stipulated that the advertisement profit is shared.

Aspects of the present invention may be implemented in a form of program instructions capable of being performed through various computer components to be recordable in a non-transitory computer-readable storage medium. The computer-readable storage medium may include program instructions, data files, data structures, or the like, alone or in combinations thereof. The program instructions recorded in the computer-readable storage medium may be designed and configured especially for implementing the present invention, or the type of the program instructions may be known to those skilled in a field of computer software. The computer-readable storage medium may include a magnetic medium, such as a hard disk, a floppy disk, and a magnetic tape; an optical recording medium, such as a CD-ROM, a DVD; a magneto-optical medium, such as a floptical disk; and a hardware device specially configured to store and perform program instructions, such as a ROM, a RAM, a flash memory, or the like. The type of the program instructions may be machine language codes that may be compiled by compilers as well as higher-level language codes capable of being executed by computers using interpreters or the like. The hardware device may be configured to be operated as one or more software modules in order to perform the process according to the present invention, and vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for dynamically providing advertisements using a computer, the method comprising:
receiving a request for access to content of a content owner;
determining an access channel for accessing the content, based on the request, using the computer;
selecting an advertisement based on the access channel; and
providing a content integration screen comprising the advertisement and the requested content.

3. The method of claim 1, wherein the determining of the access channel further comprises:
detecting whether an identification marker of a content broker is included in the request.

3. The method of claim 2, wherein the determining of the access channel further comprises determining whether a detected identification marker corresponds to an identification value of the content broker stored in a database, if the identification marker is determined to be included in the request.

4. The method of claim 1, further comprising:
determining whether the access channel connects to a content broker; and
determining whether an advertisement of the content broker is stored in a database,
wherein the selecting of the advertisement comprises selecting the advertisement of the content broker as the selected advertisement.

5. The method of claim 1, further comprising providing a uniform resource locator (URL) for the advertisement, based on the access channel.

6. The method of claim 1, further comprising calculating an advertisement profit, based on the execution of the advertisement.

7. The method of claim 6, further comprising dividing the advertisement profit between the content owner and a content broker connected to the access channel, based on a profit sharing ratio.

8. The method of claim 6, further comprising dividing the advertisement profit between the content owner and a content broker connected to the access channel, based on a number of executions of the advertisement through the content owner.

9. The method of claim 6, wherein the calculating of the advertisement profit further comprises calculating total profit sharing amount for the content owner using the following equation:
$$Total profit sharing amount of {Co}_{b} during predetermined period = {\sum }_{i = 0}^{x} ( {P}_{ai} * \frac{{N}_{ai}}{{T}_{ai}} ) * {RSR}_{{CO}_{b}} ,$$
wherein CO_{b} is the content owner, X is a number of advertisements, Pₐᵢ is an advertisement profit generated for the i-th advertisement, Tₐᵢ is total number of advertisement executions generated for the i-th advertisement, Nₐᵢ is a number of advertisement executions generated for the i-th advertisement with respect to CO_{b}, and RSR_{COb} is a profit sharing ratio between the content broker and CO_{b}.

10. A system to provide advertisements dynamically, the system comprising:
access channel analyzing unit to receive a request to access to content of a content owner, and to determine an access channel for accessing the content based on the request; and
dynamic advertisement selecting unit to select an advertisement based on the access channel, and to provide a content integration screen to a display unit, the content integration screen comprising the advertisement and the content.

11. The system of claim 10, wherein the access channel analyzing unit detects whether an identification marker of a content broker is included in the request.

12. The system of claim 11, wherein the access channel analyzing unit further determines whether the identification marker corresponds to an identification value stored in a database, if the request comprises the identification marker.

13. The system of claim 10 wherein the dynamic advertisement selecting unit further provides a uniform resource locator (URL) for the advertisement, based on the access channel, during the selection of the advertisement.

14. The system of claim 10, further comprising an advertisement profit calculating unit to calculate an advertisement profit, based on the execution of the advertisement.

15. The system of claim 14, further comprising an advertisement profit sharing unit to divide the advertisement profit between the content owner and a content broker connected to the access channel, based on a profit sharing ratio between the content owner and the content broker.

16. The system of claim 14, further comprising an advertisement profit sharing unit to divide the advertisement profit between the content owner and a content broker connected to the access channel, based on a number of executions of the advertisement through the content owner.

17. The system of claim 14, further comprising an advertisement profit sharing unit to calculate total profit sharing amount for the content owner using the following equation:
$$Total profit sharing amount of {Co}_{b} during predetermined period = {\sum }_{i = 0}^{x} ( {P}_{ai} * \frac{{N}_{ai}}{{T}_{ai}} ) * {RSR}_{{CO}_{b}} ,$$
wherein CO_{b} is the content owner, X is a number of advertisements, Pₐᵢ is an advertisement profit generated for the i-th advertisement, Tₐᵢ is total number of advertisement executions generated for the i-th advertisement, Nₐᵢ is a number of advertisement executions generated for the i-th advertisement with respect to CO_{b}, and RSR_{COb} is a profit sharing ratio between the content broker and CO_{b}.

18. A non-transitory computer-readable storage medium comprising an executable program, which when executed, operates to:
receive a request to access a content of a content owner from a terminal;
determine an access channel of the content, based on the request;
select an advertisement of a content broker connected to the access channel; and
provide a content integration screen comprising the advertisement and the content.

19. A system to provide advertisements dynamically, the system comprising:
access channel analyzing unit to receive a request to access content of a content owner, and to determine an access channel for accessing the content based on the request;
dynamic advertisement selecting unit to select an advertisement of a content broker if the access channel is determined to be via the content broker, and to provide a content integration screen in response to the request, the content integration screen comprising the advertisement of the content broker and the content of the content owner.

20-22. (canceled)
